(19) United States
(12) Patent Application Publication
(10) Pub. No.: US 2022/0322639 A1
(43) Pub. Date: Oct. 13, 2022

(54) PET LIGHT AND SHADOW TOY

(71) Applicant: NANJING DM TECHNOLOGY CO., LTD., Nanjing (CN)

(72) Inventor: Jin SHANG, NANJING (CN)

(73) Assignee: NANJING DM TECHNOLOGY CO., LTD., NANJING (CN)

(21) Appl. No.: 17/226,414

(22) Filed: Apr. 9, 2021

(51) Int. Cl. A01K 15/02

(52) U.S. Cl. CPC A01K 15/025

(57) ABSTRACT

The present invention discloses a pet light and shadow toy, and relates to the field of pet toys. The pet light and shadow toy is mainly composed of a luminous base and a shell. A moving shading member is arranged in the shell. The shell becomes a luminous shell under the action of the luminous base. The moving shading member located in the shell can rotate automatically, and blocks the corresponding part of light emitted by the luminous base. Under the cooperation of the luminous base and the moving shading member, the shell generates the light and a rotating shadow to arouse the curiosity of a pet to achieve the effect that the pet plays alone. In this way, even if a pet owner has no time to accompany the pet to play, a healthy life of the pet can be ensured.

### TECHNICAL FIELD

The present invention relates to a pet toy, and particularly to a pet light and shadow toy.

### BACKGROUND

Nowadays, the pet has become a member of life of most people. As a companion, more and more pet toys have appeared in the market.

Because the pet, especially the cat, is naturally curious about light, various luminous pet toys can be seen in the market. However, the existing pet toys, such as Chinese patent with publication number CN201312513Y, amuse the pet by irradiating light on the ground to generate light spots, which often requires a pet owner to hold and operate the pet toys, thereby achieving the purpose of amusing the pet and increasing the interaction between the pet owner and the pet. However, when the pet owner is busy, the pet owner often has less time to interact with the pet and amuse the pet, which is easy to influence the physical and mental health of the pet.

### SUMMARY

To solve the above technical problem, the purpose of the present invention is to provide a pet light and shadow toy which can allow a pet to play alone.

To achieve the above purpose, the present invention adopts the following technical solution: a pet light and shadow toy is mainly composed of a luminous base and a shell, wherein a moving shading member is arranged in the shell.

By adopting the above technical solution, the shell becomes a luminous shell under the action of the luminous base. The moving shading member located in the shell can rotate automatically, and blocks the corresponding part of light emitted by the luminous base. Under the cooperation of the luminous base and the moving shading member, the shell generates the light and a rotating shadow to arouse the curiosity of a pet to achieve the effect that the pet plays alone. In this way, even if a pet owner has no time to accompany the pet to play, a healthy life of the pet can be ensured.

Preferably, the shell is tarpaulin.

By adopting the above technical solution, light transmission can be effectively realized; and meanwhile, the tarpaulin has toughness and is difficult to be damaged after played by the pet for a long time.

Preferably, a hole is formed in the shell.

By adopting the above technical solution, the pet can peep at the moving shading member in the shell through the hole, making the pet want to capture the moving shading member, thereby increasing the interest of the pet.

Preferably, the shell is connected with the luminous base through a clamping ring.

By adopting the above technical solution, the shell can be better connected with the luminous base.

Preferably, a motor is arranged in the luminous base, and the motor is matched and connected with the moving shading member.

By adopting the above technical solution, the motor can provide power for the moving shading member, so that the moving shading member can revolve around the luminous base.

Preferably, the motor is connected with a motor control board.

By adopting the above technical solution, the motor can rotate irregularly under the control of the motor control board, so as to drive the moving shading member to move irregularly.

Preferably, the motor control board is a micro-control unit.

By adopting the above technical solution, the micro-control unit has small volume and high integration level, and can better control the motor without occupying the space.

Preferably, LED lamps are arranged in the luminous base, and the LED lamps are arranged on printed circuit boards.

By adopting the above technical solution, the luminous base emits light through the LED lamps, and the printed circuit boards save the wiring of the LED lamps and improve the production efficiency.

Preferably, a rotating cap head is arranged at the connection between the bottom of the moving shading member and the luminous base.

By adopting the above technical solution, the rotating cap head is matched with the motor in the luminous base, which can effectively achieve a transmission effect to rotate the moving shading member.

Preferably, a shading part of the moving shading member is in the shape of an animal.

By adopting the above technical solution, a shadow formed finally on the shell can be in the shape of the animal to arouse the capturing instinct of the pet, so as to increase the interest.

Compared with the prior art, the present invention has the advantages that: (1) the pet can play alone without the interaction between the pet owner and the pet; (2) the shadow of movement can arouse the curiosity and capturing instinct of the pet, thereby increasing the interest; (3) Light and shadow move on the shell, and the product is static, so the size of the space is not limited.

### DESCRIPTION OF DRAWINGS

FIG. 1 is an exploded structural schematic diagram of embodiment 1 of the present invention.

In the FIGURES: 1. shell; 2. luminous base; 3. moving shading member; 4. battery pack; 5. battery cover plate; 6. power switch; 7. clamping ring; 101. hole; 201. LED lamp; 202. printed circuit board; 203. base cover plate; 204. transparent lamp shade; 205. motor; 206. motor control board; 301. shading part; 302. elastic filament; 303. rotating cap head.

### DETAILED DESCRIPTION

The present invention is further described below in detail in combination with the drawings and embodiments.

### Embodiment 1

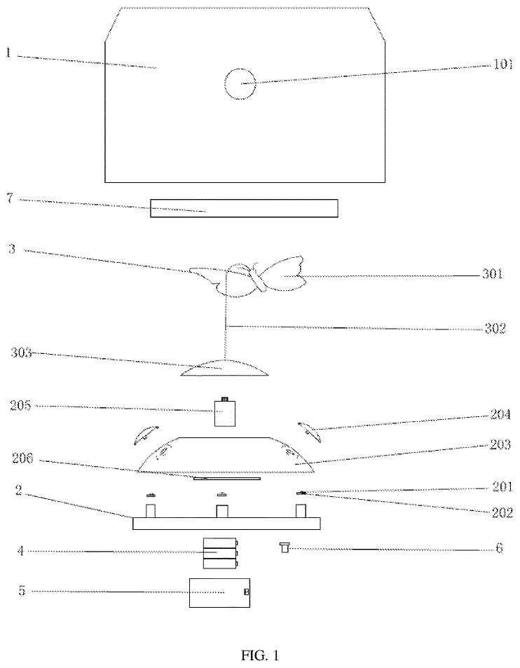

A pet light and shadow toy, as shown in FIG. 1, is mainly composed of a shell 1 and a luminous base 2. The shell 1 is made of transparent material which is specifically a three-dimensional polygonal tarpaulin and can shine under the action of the light of the luminous base 2. The material of the tarpaulin has toughness, and is not easy to be damaged by the pet, thereby increasing the service life. A moving shading member 3 is arranged in the tarpaulin. The moving shading member 3 rotates around the upper surface of the luminous base 2 in the tarpaulin, so as to block the light emitted by the luminous base 2. A shadow of movement is formed on the shell 1 to arouse the curiosity of the pet. Because the moving shading member 3 rotates constantly without human control, the pet can play with the light and shadow toy alone, so that the pet can have a healthy life when the owner has no time to accompany the pet.

In the present embodiment, a hole 101 is formed in the tarpaulin. In this way, the pet can see the moving shading member 3 in the tarpaulin through the hole, which can increase the curiosity. In particular, after a cat sees the moving shading member 3 in the tarpaulin, the capturing instinct of the cat can be aroused to try to capture the moving shading member 3, which increases the interest.

In the present embodiment, the luminous base 2 is located at the bottom of the shell 1, and the two are detachably connected through a clamping ring 7. The clamping ring 7 is specifically a ring arranged at the bottom of the shell 1, and the shell 1 part in which the ring is located is a through hole matched with the diameter of the luminous base 2. The inner side of the ring is provided with a convex structure for clamping, and the convex structure is made of shape-changing material. The side surface of the luminous base 2 is provided with a corresponding groove. The installation of the luminous base 2 and the shell 1 is completed by pushing the luminous base 2 into the clamping ring 7 and clamping the convex structure and the groove on the side surface of the luminous base 2.

In the present embodiment, the luminous base 2 is mainly composed of a base and a base cover plate 203 located above the base. The base cover plate 203 is located in the shell 1 after installed. The base cover plate 203 is provided with a plurality of transparent lampshades 204. The transparent lampshades 204 are connected with the base cover plate 203 through clamping grooves, and can diffuse the light in the luminous base 2. Holes through which the light passes are formed on the transparent lampshades 204 of the base cover plate 203 in corresponding positions. A plurality of LED lamps 201 are arranged in the luminous base 2 correspondingly with the transparent lampshades 204. The LED lamps 201 are installed on the printed circuit boards 202, and realize circuit connection through the printed circuit boards 202, which can save the process of wiring and improve the production efficiency. The base of the luminous base 2 is provided with vertical columns for fixing the printed circuit boards 202. Each vertical column has a groove matched with the printed circuit board. After the printed circuit boards 202 are clamped into the vertical columns, the positions of the LED lamps can be ensured to be fixed, and may not be moved or even damaged by the pet during playing.

In the present embodiment, a motor 205 is arranged on the upper part in the luminous base 2. The moving shading member 3 is specifically composed of a shading part 301 at the top, a rotating cap head 303 at the bottom and an elastic filament 302 connecting the two. The elastic filament 302 is specifically an iron wire. One end of the iron wire is fixedly arranged on the rotating cap head 303. The rotating cap head 303 is matched and connected with the motor 205 in the luminous base 2. Under the drive of the motor 205, the rotating cap head 303 rotates, so as to drive the shading part 301 on the top of the elastic filament 302 to rotate. Because the elastic filament 302 has elasticity, the elastic filament 302 shakes in the rotation process of the rotating cap head 303. The interior of the shading part 301 is of a hollow structure. An object block which can make a sound through impact is arranged in the shading part 301. When the object block shakes with the elastic filament 302, the object block can make certain sound to increase the attraction to the pet.

In the present embodiment, the motor 205 is provided with a motor control board 206. The motor control board 206 is specifically a micro-control unit, has high integration level, small volume and high controllability, does not occupy too much space in the luminous base 2, and can control the rotation of the motor 205, so that the motor 205 can rotate irregularly, so as to drive the shading part 301 of the moving shading member 3 to rotate irregularly around the luminous base 2 in the shell 1.

In the present embodiment, the base of the luminous base 2 is provided with a battery groove in which a battery pack 4 can be arranged. The battery pack 4 can be movably connected in the battery groove to facilitate the replacement of a battery. A battery cover plate 5 is arranged on the surface of the battery groove, which can achieve the effect of shielding the battery pack 4. The battery cover plate 5 and the base of the luminous base 2 are fixed by screws to ensure that the battery cover plate 5 may not be opened by the pet. The battery pack 4 is connected with the printed circuit boards 202 and the motor control board 206 through a circuit, so as to supply power to the motor 205 and the LED lamps. The bottom of the luminous base 2 is provided with a power switch 6, and on-off of the circuit is controlled by the power switch 6 to achieve the purpose of controlling the switch of the light and shadow toy.

In the present embodiment, the shading part 301 of the moving shading member 3 is in the shape of an animal, specifically in the shape of a butterfly. In this way, a shadow formed or the appearance seen by the pet from the hole in the shell 1 can be more realistic, to achieve the purpose of better attracting the pet, arouse the capturing instinct of the pet and increase the interest.

In the present embodiment, the bottom of the luminous base 2 is a plane and can be statically placed on the ground. Because light and shadow are formed in the shell only through the luminous base 2 and the moving shading member 3, the requirement for the space is not high. Even if the space is small, there is no need to worry about the problem of small movement range and the pet can still play in the space. The pet light and shadow toy is especially suitable for nocturnal cats to play.

### Embodiment 2

The present embodiment is different from the embodiment 1 in that: the shell 1 has a round nylon surface and a transparent color; the bottom luminous base 2 is a plane parallel to the ground; and the shading part 301 of the internal moving shading member 3 is in the shape of a dragonfly. This is only a preferred embodiment. The shading part 301 of the moving shading member 3 may also be in the shape of other animals of a beetle, a mouse, and the like.

In the present embodiment, the shading part 301 is of a hollow structure. A bell is installed in the shading part 301. When the shading part 301 shakes with the elastic filament 302, the bell can make sound to increase the attraction to the pet.

In the present embodiment, no hole is formed in the shell 1.

### Embodiment 3

The present embodiment is different from the embodiment 1 in that: the shell 1 is a rectangular plastic shell and has a transparent color.

In the present embodiment, the moving shading member 3 is in the shape of a feather. This is only a preferred embodiment. The moving shading member 3 may also be in other different shapes.

In the present embodiment, the LED lamps in the luminous base 2 are installed directly through the wiring without using the printed circuit boards 202.

Although preferred embodiments of the present invention are described in detail above, it should be understood that for those skilled in the art, various variations and changes can be made to the present invention. Any modification, equivalent replacement, improvement, etc. made within the spirit and the principle of the present invention shall be included within the protection scope of the present invention.

1. A pet light and shadow toy, which is mainly composed of a luminous base (2) and a shell (1), wherein a moving shading member (3) is arranged in the shell (1).

2. The pet light and shadow toy according to claim 1, wherein the shell (1) is tarpaulin.

3. The pet light and shadow toy according to claim 1, wherein a hole (101) is formed in the shell.

4. The pet light and shadow toy according to claim 1, wherein the luminous base (2) is connected with the shell (1) through a clamping ring (7).

5. The pet light and shadow toy according to claim 1, wherein a motor (205) is arranged in the luminous base (2), and the motor (205) is matched and connected with the moving shading member (3).

6. The pet light and shadow toy according to claim 5, wherein the motor (205) is connected with a motor control board (206).

7. The pet light and shadow toy according to claim 6, wherein the motor control board (206) is a micro-control unit.

8. The pet light and shadow toy according to claim 1, wherein LED lamps (201) are arranged in the luminous base (2), and the LED lamps (201) are arranged on printed circuits board (202).

9. The pet light and shadow toy according to claim 1, wherein a rotating cap head (303) is arranged at the connection between the bottom of the moving shading member (3) and the luminous base (2).

10. The pet light and shadow toy according to claim 1, wherein a shading part (301) of the moving shading member (3) is in the shape of an animal.
